(19) United States
(12) Patent Application Publication
(10) Pub. No.: US 2023/0103857 A1
(43) Pub. Date: Apr. 6, 2023

(54) SEI PREFORMED GRAPHITE AND ASSOCIATED METHODS, APPARATUS, AND PRODUCTS

(71) Applicant: The Trustees of Indiana University, Bloomington, IN (US)

(72) Inventor: Jian Xie, Zionsville, IN (US)

(21) Appl. No.: 17/937,136

(22) Filed: Sep. 30, 2022

Related U.S. Application Data
(60) Provisional application No. 63/251,064, filed on Oct. 1, 2021.

(51) Int. Cl. H01M 4/04; H01M 4/133; H01M 4/62; C25D 5/54

(52) U.S. Cl. CPC H01M 4/0452; H01M 4/133; H01M 4/625; C25D 5/54; H01M 2004/027

(57) ABSTRACT

Solid electrolyte interphase (SEI) preformed graphite, methods of forming SEI preformed graphite, apparatus for forming SEI preformed graphite, and electrochemical battery cells including an SEI preformed graphite electrode. A method of making SEI preformed graphite includes forming an SEI coating on individual graphite particles in a suspension of graphite particles in an electrolyte by generating a voltage between a cathode and an anode having a lithium source across the suspension. An SEI preformed graphite includes a graphite powder having a preformed SEI layer on each of a plurality of graphite particles in powder form. The SEI layer covers the exterior surface of each of the graphite particle in the graphite powder. An electrochemical battery cell may be formed using the SEI preformed graphite. A flow cell apparatus is provided for forming the SEI preformed graphite.

### CROSS-REFERENCE TO RELATED APPLICATIONS

This application claims the benefit of U.S. Provisional Application No. 63/251,064 filed Oct. 1, 2021, the contents of which are incorporated herein by reference.

### STATEMENT REGARDING FEDERALLY SPONSORED RESEARCH

This invention was made with government support under contract number DE-ACO2-06CH11357 awarded by the U.S. Department of Energy. The government has certain rights in the invention.

### BACKGROUND OF THE INVENTION

The invention relates generally to solid electrolyte interphase (SEI) preformed graphite, methods of forming SEI preformed graphite, apparatus for forming SEI preformed graphite, and electrochemical battery cells including an SEI preformed graphite electrode.

High energy density lithium-ion batteries (LIBs) are continuously pursued to fulfill the growing demands of the energy storage markets. However, the irreversible lithium loss due to the formation of solid electrolyte interphase (SEI) in the initial cycle on the conventional graphite anode greatly reduces the overall cell energy density of lithium-ion batteries, that is, the lost Li ions from forming SEI leads to the decrease of Li ions for the intercalation. For example, conventional commercial LIB battery cells typically are formed of a lithium transition metal oxide cathode (e.g., LiFePO4, LiCoO2, and LiMn2O4, etc.) and a graphite anode. Their energy density is dictated by the reversible number of the Li ions shuttled between the anode and cathode within per cell mass and cell voltage. However, during the initial charge process, there are 5-20% of the Li ions irreversibly consumed due to the formation of SEI layer on graphite surface. In the following cycles, there will be 5-20% of Li ions shortage for shuttling between the anode and cathode in the LIB cell operation. As the consequence, this initial lithium loss (ICL) greatly reduces the overall battery cell energy density. Some higher capacity anode materials, such as Sn and Si, make this situation even worse considering their much lower initial Coulombic efficiency (ICE).

To address this issue, methods of cathode prelithiation using additives have been widely explored to compensate this lithium loss. However, these additives with high lithium contents inevitably lower the loading of the cathode active materials. For example, cathode prelithiation with high Li content sacrificial reagents has been widely explored as a common strategy to compensate this lithium loss. The high lithium content of those reagents could greatly compensate the lithium loss and thus increase the full cell energy density. Nevertheless, the additives of these reagents inevitably lower the active cathode material loading and leave inactive residues which make it hard to fully unlock the potential of the full cell energy density. Moreover, those residues generated after the lithium compensation are typically not electrically conductive (e.g., S, metal oxide, Table 1) and consequently, destroy the spatial continuity of the whole electrode for electron transportation. The use of these additives may also be accompanied with the evolution of undesired gas products such as CO₂, O₂ and N₂, raising the safety concerns of battery operation.

On the other hand, direct anode prelithiation techniques using chemical methods or stabilized lithium metal powder (SLMP) are effective approaches to elevate ICE but easily give rise to a further Li intercalation into these anode materials (e.g., graphite, SiOₓ). In this regard, an overcharged status is created once coupling them directly with most of the commercial Li-containing cathode materials (e.g., LiCoO₂, LiFePO₄). Tedious procedures such as redundant Li extraction, cell disassembly, electrode cleaning, and further full cell re-assembly are required for these prelithiated anode materials to ensure battery safety.

In contrast, an artificial SEI coating has been perceived as another way to protect anode material from potential side reaction. Certainly, the reduced SEI propagation with an artificial SEI layer typically leads to an elevated ICE and electrochemical performance. However, it is hard to control the loading of these artificial SEI coatings to a precise level, which is crucial to maximize the energy density of a battery cell with a minimum inactive material addition. Therefore, a complete solution to minimize the Li loss remains a persistent challenge.

Graphite is the main anode material choice for conventional commercial LIBs due to its superior reversibility and low cost. Unfortunately, the initial lithium loss caused by the SEI formation on the graphite anode typically equals approximately 20˜80 mAh g⁻¹ of lithium specific capacity. Therefore, it would be desirable to directly preform a SEI layer on graphite with certain degree (e.g. >40 mAh g⁻¹) before its application on LIBs in order to reduce or even eliminate this tendency of conventional LIBs.

### BRIEF SUMMARY OF THE INVENTION

According to one nonlimiting aspect, a method of making SEI preformed graphite is provided. The method includes disposing a suspension of graphite particles in an electrolyte between and in ionic contact with a cathode and an anode, wherein the anode comprises a lithium source, forming an SEI coating on the individual graphite particles in the suspension by generating a voltage between the cathode and the anode and across the suspension.

According to another nonlimiting aspect, an SEI preformed graphite is provided. The SEI preformed graphite includes a graphite powder having separate individual graphite particles, and a preformed SEI layer on each of a plurality of the graphite particles in powder form. The SEI layer is directly formed over and substantially completely covers the exterior surface of each of the plurality of graphite particle in the graphite powder.

According to yet another nonlimiting aspect, an electrochemical battery cell is provided. the electrochemical battery cell includes a first electrode of the SEI preformed graphite, a second electrode, and an electrolyte operatively coupling the first electrode with the second electrode to allow ions to flow from the one of the electrodes to the other of the electrodes.

According to still another nonlimiting aspect, a flow cell apparatus for forming SEI preformed graphite is provided. The flow cell apparatus includes a cathode, an anode including lithium spaced apart from the cathode and forming a volume between the cathode and the anode, a battery separator disposed between and separating the volume between the cathode and the anode, a permeable interlayer disposed between the battery separator and the cathode and defining a flow space between the interlayer and the battery separator and within the volume, a mixer configured to mix graphite powder in an electrolyte, and a pump configured to provide a flow of mixed graphite powder and electrolyte from the mixer to the flow space to engage graphite particles of the graphite powder against the cathode.

In some arrangements, the methods, SEI preformed graphite, electrochemical battery cells, and/or flow cell apparatus of the present disclosure may improve the energy density of LIBs by mitigating initial lithium loss and/or providing products, systems, and/or methods for achieving such improvements. These and other aspects, arrangements, features, and/or technical effects will become apparent upon detailed inspection of the figures and the following description.

### BRIEF DESCRIPTION OF THE DRAWINGS

FIG. 1A is a schematic of a flow cell configured for making SEI preformed graphite according to some aspects of the invention

FIG. 1B is a schematic illustration of preformation of an SEI layer on the surface of graphite particles using the flow cell of FIG. 1A.

FIG. 2 shows an example system set-up for preparing pre-SEI graphite using the flow cell of FIG. 1A.

FIGS. 3A-3J show morphologies of pristine graphite and Pre-SEI graphite according to aspects of the present invention. FIGS. 3A-3C are SEM images of pristine graphite, and FIGS. 3D-3F are SEM images of pre-SEI graphite according to aspects of the present invention. FIGS. 3G and 3H are TEM images of pristine graphite, and FIGS. 31 and 3J are TEM images of pre-SEI graphite according to aspects of the present invention.

FIGS. 4A through 4F shows XPS spectra acquired from pre-SEI surface: (FIG. 4A) Li 1s, (FIG. 4B) O 1s, (FIG. 4C) C 1s, (FIG. 4D) N 1s, (FIG. 4E) F 1s and (FIG. 4F) S 2p.

FIGS. 5A-5E show graphs of electrochemical performance of Pre-SEI graphite. FIG. 5A shows initial CV curves of graphite and Pre-SEI graphite anodes. FIG. 5B shows initial charge and discharge curves of graphite and pre-SEI graphite of the present invention at 0.1 C-rate, which indicate the initial capacity loss after initial cycle. FIG. 5C shows charge and discharge curves of graphite at different C-rates. FIG. 5D shows pre-SEI graphite of the present invention at different C-rates. FIG. 5E shows C-rate performance of graphite and pre-SEI graphite of the present invention.

FIG. 6 is a graphic illustrating calculated cathode specific capacities and energy densities of NCM-graphite cells after initial cycle using different cathode additives and Pre-SEI graphite.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of the embodiment(s) to which the drawings relate. The following detailed description also describes certain investigations relating to the embodiment(s) depicted in the drawings, and identifies certain but not all alternatives of the embodiment(s). As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

The present disclosure provides a novel approach to solve one or more of the challenges described above with conventional LIB anodes. The present disclosure provides a facile method and system for graphite prelithiation by pre-forming SEI layers on the surface of graphite powders to form SEI preformed graphite (also referred to herein as “Pre-SEI graphite”) utilizing a specially designed flow cell. With these techniques, the Li accommodation in the graphite anode can be controlled by the operating time and current density in the flow cell for the electrochemical SEI formation. As a result, we demonstrate a 10% initial Columbic efficiency increase of a LiFePO₄ (lithium ferrophosphate, or “LFP”) electrode in a full electrochemical battery cell configuration using the Pre-SEI graphite, compared with the pristine graphite anode. The electrochemical preformation of SEI on the graphite powders may in some arrangements offer a complete solution to offset initial lithium loss without a sacrifice of active cathode loading.

According to some aspects of the disclosure, a new method to prepare SEI preformed graphite (Pre-SEI graphite) is provided in order to mitigate the initial lithium loss by reducing SEI formation process in battery cell, which is intrinsically different from conventional cathode or anode prelithiation techniques. According to other aspects of the disclosure, this pre-SEI graphite may be fabricated in a new flow cell that is configured to electrochemically mimic the formation of SEI within battery cells. This new concept of Pre-SEI graphite enables a direct Li compensation on the freestanding graphite powders before being fabricated into an electrode (e.g., a cathode or an anode) rather than on a sophisticated already-fabricated electrode. This feature is also beneficial for the further scale up in industrial applications. Owing to the preformation SEI on graphite surface, approximately ˜25 mAh g⁻¹ of the initial lithium loss has been compensated based on graphite half cells. The techniques of the present disclosure may lead to pre-SEI graphite providing a complete solution to solve the ICL issue, for example with the development of the electrolyte modification and flow cell design to a higher degree of SEI preformation. In any event, the inventors believe that the systems and techniques for electrochemical preformation of SEI on graphite disclosed herein open a new avenue to improve LIBs energy density by mitigating initial lithium loss.

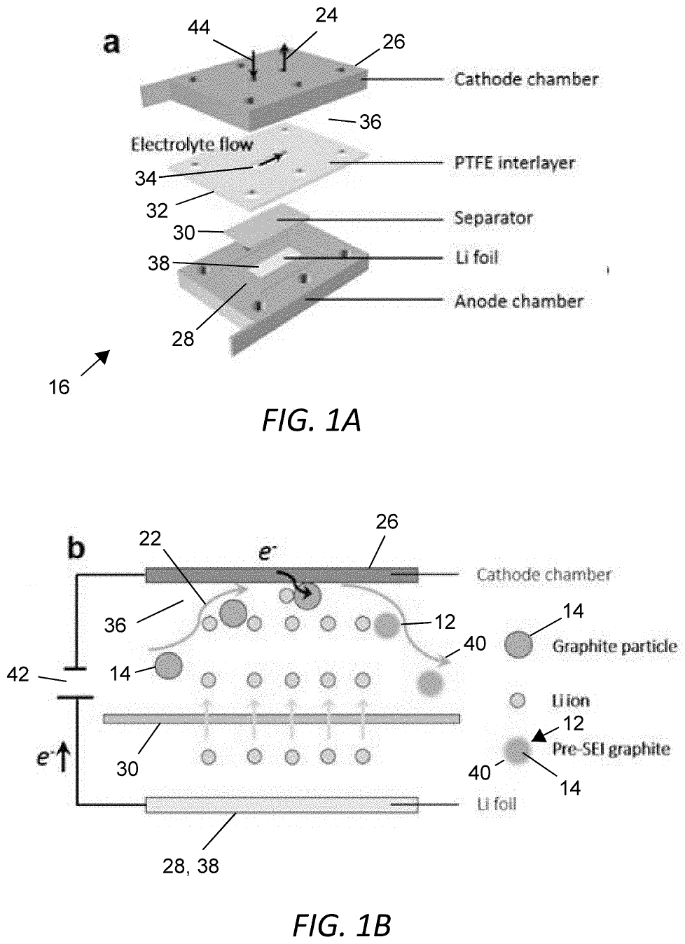

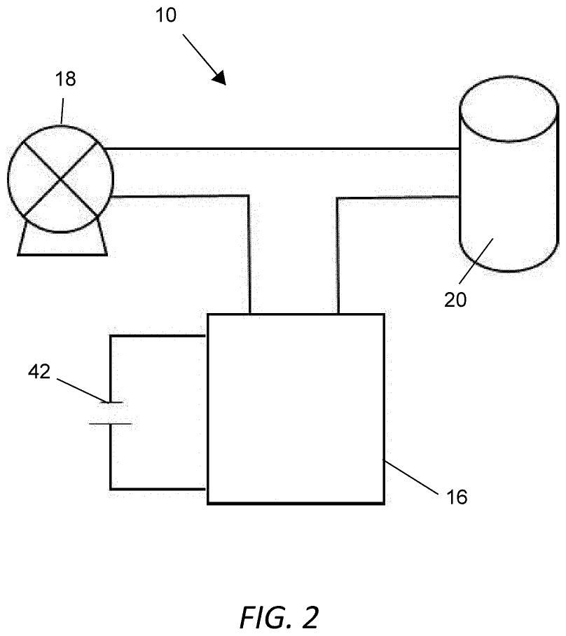

Turning now to the nonlimiting embodiments represented in the drawings, FIGS. 1A, 1B, and 2 illustrate various aspects of a flow cell apparatus 10 configured to form SEI preformed graphite 12 and a method of forming the SEI preformed graphite 12 from graphite particles 14. The graphite particles 14 are individual particles of graphite in a powder form, although other sources of graphite particles may also be possible. As best seen in FIG. 2, the flow cell apparatus includes a flow cell 16, a pump 18, a mixer 20, and a voltage source 42. The mixer 20 is configured to thoroughly mix the graphite particles 14 from a graphite powder with a liquid electrolyte 22 to form a suspension 24 of the graphite particles in the electrolyte. In this example, the mixer 20 includes a magnetic stirrer in container (beaker), but other mixing arrangements suitable for thoroughly mixing the graphite particles of a graphite powder with the electrolyte 22 to form the suspension 24 can be used. The pump 18 is configured to pump the suspension 24 in a loop from the mixer 20 to the flow cell 16 and back to the mixer, for example in-line with conduits connecting the mixer 20 to the flow cell 16.

As best seen in FIG. 1A, the flow cell 16 includes two electrodes, a cathode 26 and an anode 28. The cathode 26 and anode 28 are spaced apart to define a volume therebetween for holding the electrolyte 22 so as to be able to operatively contact both the cathode 26 and the anode 28 and thereby provide for ion transfer. The cathode 26 includes a source of lithium, such as a lithium foil 38 and/or may be made and/or contain lithium. A battery separator 30 is operatively disposed between the cathode 26 and the anode 28 and divides the volume so as to keep the two electrodes apart to prevent electrical short circuits while also allowing the transport of ionic charge carriers for closing the circuit during the passage of current in the flow cell 16. Any suitable type of battery separator may be used. A permeable interlayer 32 is disposed between the cathode 26 and the anode 28. The permeable interlayer 32 preferably includes a plurality of through holes, such apertures 34, extending between the opposite sides to allow a limited amount of fluid flow of the electrolyte 22 from one side to the other side of the interlayer 32. A flow space 36 is defined by and between the interlayer 32 and the cathode 26. The flow space 36 receives the suspension 24 of the electrolyte 22 and graphite particles 14 from the mixer 20. In this arrangement, the suspension 24 is directed along a flow path 44 with an inlet into the flow space 36 and an outlet from the flow space 36 that is part of a closed fluid circuit with the mixer 20 with the pump 18 in line in the closed fluid circuit configured to pump the suspension 24 through the flow space 36. However, other arrangements for delivering the suspension 24 into the flow space 36 and configured to cause graphite particles 14 in the suspension 24 to contact the cathode 26 while an electric voltage is present across the cathode 26 and anode 28 could be provided.

In order to form the SEI preformed graphite 12 using the flow cell apparatus 10, volume between the cathode 26 and the anode 28 is filled with enough of the suspension 24 to allow the suspension to contact both the cathode and anode and allow for ion transfer therebetween in any suitable manner. Thereafter, an SEI coating 40 is formed on the individual graphite particles 14 by generating a voltage across the suspension 24 between the cathode 26 and the anode 28. Preferably, the flow path 44 and the interlayer 32 are configured so as to ensure that suspension 24 contacts and flows across and/or against the surface of the cathode 26 so as to ensure that individual graphite particles 14 in the electrolyte 22 contact the surface of the cathode while the voltage is realized. In this example, the flow space 36 thus also forms a reaction space where the graphite particles 14 can react with lithium ions in the electrolyte 22 to form the SEI coating 40. The resulting SEI preformed graphite 12 is formed of a graphite particle 14 having the SEI coating 40 coating substantially the entire outer surface of individual graphite particles 14.

After subsequent process steps, such as drying, the SEI preformed graphite 12 can be accumulated again into a powder form, in which some or all of the individual graphite particles are individually coated with the SEI coating 40 around their entire exterior surfaces. The resulting SEI preformed graphite 12 may subsequently be used to form other products, such as an electrode in an electrochemical battery cell. For example, an anode of the battery cell can be formed of the SEI preformed graphite 12 bound to electrically conductive carbon black by a binder and shaped into a desired form for the form factor of the battery. Other uses of the SEI preformed graphite 12 are also possible.

Further details regarding nonlimiting examples of the flow cell apparatus 10, SEI preformed graphite 12, process for forming the SEI graphite 12, and a battery cell formed from the SEI preformed graphite related to various experimental procedures leading the present invention(s) are described in more detail hereinafter.

SEI preformation in flow system: The preforming SEI processes were conducted in a specially designed semi-flow cell 16, in which 50 mL 2 M LiTFSI/0.4 M LiNO₃ in DOL was used as the electrolyte 22. It is noted that typical ethylene carbonate (EC) and ethyl methyl carbonate (EMC) based electrolytes (e.g. 1.2 M LiPF₆ in EC and EMC) may lead to severe graphite agglomeration and hinder the electrolyte flow. 150 mg graphite powers were dispersed into this electrolyte 22 before the operation of the flow cell system 10. In this flow cell 16, as best seen in FIG. 1A, one piece of lithium foil 38 was placed on the steel anode 28 side (anode chamber) as reference and counter electrode, followed by a Celgard 2400 separator 30. A polytetrafluoroethylene (PTFE) interlayer 32 with a thickness of 1 mm was applied between the anode chamber and cathode chamber. After the assembly of this flow cell in a Ar-filled glove box, it was connected with a peristaltic pump 18 (MasterFlex, Cole-Parmer) and one electrolyte container 20 with tubes (FIG. 51). Moreover, the electrolyte container 20 was kept stirring during the operation of the flow system to ensure a uniform dispersion of graphite particles 14 in the electrolyte 22 and avoid any settlement. With the connection of the whole flow system 10 outside of the glove box, the system was purged by Ar flow for 10 mins to remove any O₂ gas. Then, the electrolyte flow 44 was cycled for 30 mins first (flow rate: 10 mL/min) without a connection to a potentiostat to obtain a superior wetting of both Li foil 38 and separator 30. During the finial operation, the voltage window of the flow cell 16 was set between 0.005 V and 2.000 V (vs. Li⁺/Li) to mimic the SEI formation process of the graphite in a normal coin cell with a current of 93 μA ( 1/600 C for 150 mg graphite) using a potentiostat 22. After one charge/discharge cycle of SEI formation, these Pre-SEI graphite powders 12 were washed with DOL using a centrifuge and were dried for further use. The main products of our preformed SEI 40 are Li₂CO₃ and LiF, both of which are stable at air condition. Thus, the contamination of air and moisture to our Pre-SEI graphite 12 could be reduced with a limited battery performance influence.

Electrolyte and electrode preparation: The electrolyte used in coin cells (electrochemical battery cells) was prepared by dissolving 1.2 M LiPF₆ in the EC-EMC mixture solvent (3:7 by mass) with 2 wt. % additives of FEC. The (non-SEI) graphite electrode and the pre-SEI graphite electrode were prepared by slurry coating on Cu foil, which comprised 80 wt. % active materials (graphite or Pre-SEI graphite 12, respectively), 10 wt. % Super P, and 10 wt. % polyvinylidene difluoride (PVDF) as the binder. Similarly, LFP electrodes were followed the same mass ratio of 8:1:1 for LFP, Super P, and PVDF on Al foil. The areal capacity loading was about 1.6 mg cm⁻², and 4.5 mg cm⁻² of anode materials and cathode materials, respectively.

Materials: Graphite powders (MescoCarbon MicrBeads, MCMB), Li foil (99.9%), LiFePO₄ (LFP) and Super P conductive carbon black were obtained from MTI Corporation (USA). Battery-grade LiPF₆, ethylene carbonate (EC), and ethyl carbonate (EMC) were obtained from Novolyte Technologies (China). 1,3-dioxolane (DOL, 99%), LiNO₃ (99%), and Fluoroethylene carbonate (FEC, 99%) were purcfigure hased from Sigma-Aldrich (USA). Lithium bis(trifluoromethanesulfonyl)imide (LiTFSI, >98%) was obtained from TCI chemicals (Japan).

Electrochemical and materials characterization: Electrochemical tests were performed using CR2032 type coin cell. For half-cells, Li foils were used as the counter/reference electrode, and as-prepared electrodes (graphite, Pre-SEI graphite, LFP) were used as working electrodes (d=15 mm) with one piece of polypropylene separator (d=19 mm) (Celgard 2400) (USA). 75 μL of as-prepared EC-based electrolytes were used in each cell. The cut-off voltage was controlled at 0.005-2.000 V and 2.400-4.000 V (vs. Li⁺/Li) for graphite and LFP, respectively. For full cells (electrochemical battery cells), the mass ratio of the LFP and graphite (or Pre-SEI graphite 12) was controlled to 2.8:1, which corresponds to a N/P ratio of ˜1.02 according to the half-cell data. The cut-off voltage was controlled at 2.400-3.800 V (vs. Li⁺/Li) for these full cells. The cyclic voltammetry (CV) analyses of graphite and Pre-SEI graphite were conducted using a Solartron potentiostat (Ametek, UK) with a range of 0.005-2.000 V (Li⁺/Li) at a scan rate of 0.5 mV s⁻¹. The electrochemical impedance spectra (EIS) were measured using a Solartron potentiostat with an AC voltage of 5 mV in the frequency range from 1000 kHz and 0.01 Hz (Model SI 1287). Galvanostatic charge-discharge of all of the half-cells and full cells were collected on a LAND-CT2001 battery testing instrument (Land Corp, China) at a determined C rate. The current density and specific capacity were based on the mass of the active materials loading. The scanning electron microscopy (SEM) and transmission electron microscopy (TEM) images were acquired from a JEOL 7800F and JEOL 2100F, respectively (JEOL, Japan). XPS data of surface chemistry was acquired using PHI 5000 VersaProbe II system (Physical Electronics, USA) that attached to an argon-atmosphere glovebox to avoid any contamination of moisture and air. The high-resolution spectra were obtained under the following conditions: 100 μm beam (25 W) with Al Kα radiation (hv)=1486.6 eV), Ar⁺-ion and electron beam sample neutralization, fixed analyzer transmission mode, and pass energy of 23.50 eV. The Shirly background data were subtracted from all spectra. The spectra were fitted to multiple Gaussian peaks by using the software package (XPSPEAK). The reported atomic concentrations were calculated from survey scans. The structure of graphite and Pre-SEI graphite were examined by X-ray powder diffraction (XRD) tests (Bruker D8 Discover, Bruker USA).

Design of Pre-SEI graphite: To evaluate the concepts of the Pre-SEI graphite 12 disclosed herein for mitigating the initial lithium loss, full cell energy density calculations based on LiNi_{0.8}Co_{0.1}Mn_{0.1}O₂ (NCM)-graphite full cell was conducted and compared with those typical cathode prelithiation additives, as shown in Table 1 below.

TABLE 1
Representatives of cathode prelithiation additives
to offset ICL.

| | | Specific Capacity | Lithiation |
|---|---|---|---|
| No. | Additives | (mAh/g) | Residues |
| 1 | Li₂C₃O₅ | 430 | CO₂, C |
| 2 | Li₂C₂O₄ | 545 | CO₂, C |
| 3 | LiN₃ | 567 | N₂ |
| 4 | Cu/Li₂O (1/1) | 574 | CuO |
| 5 | Ni/Li₂O (1/1) | 605 | NiO |
| 6 | LiS₂/Co | 711 | CoS₂ |
| 7 | Fe/Li₂O (3/4) | 747 | Fe₃O₄ |
| 8 | Fe/Li₂O (2/3) | 799 | Fe₂O₃ |
| 9 | Li₂S | 1166 | S |
| 10 | Li₃N | 1761 | N₂ |

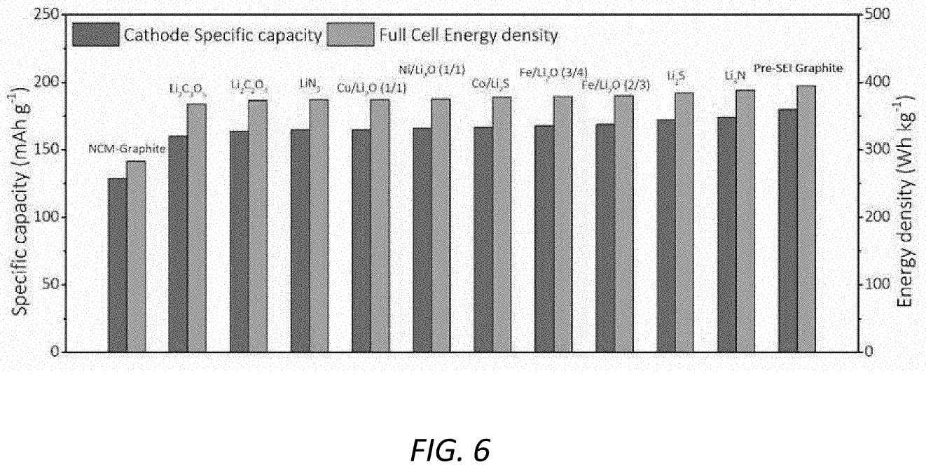

After the initial charge process, the high lithium content of those additives could greatly compensate the lithium loss and thus increase the cathode specific capacity and full cell energy density in the following cycles, as shown in FIG. 6. However, the inactive residues were generated after the lithium compensation. Unfortunately, those residues such as S and metal oxides (Table 1), are typically electrical insulating, which leads to a negative effect on electron transportation within the cathode electrode. Moreover, undesired gaseous N₂ and CO₂ may be produced using some high lithium content additives (i.e. Li₃N, Li₂C₃O₅), posting a battery safety issue as well. From this, it can be seen that a novel and complete lithium compensation strategy without inactive residues is highly desired.

Because of this, we developed the “Pre-SEI graphite” 12 that is, a preformed SEI layer 40 on graphite powder 14 without using a battery cell disclosed herein. In this configuration, a SEI layer 40 is directly formed over the surface of graphite particles 14 in the anode and no inactive residues are produced, which means the full cell energy density could be elevated to a maximum extent compared those cathode additives in FIG. 6 and Table 1. According to our calculations, a fully Pre-SEI graphite (395 Wh kg⁻¹) could further increase up to 7% reversible energy density based on a NCM-graphite full cell compared with the cathode prelithiation methods (i.e. Li₂C₃O₅, 368 Wh kg⁻¹) previously known. The present Pre-SEI graphite concept is different from the reported anode prelithiation methods previously known. There is no further lithium intercalation process involved to avoid an overcharged status when the Pre-SEI graphite 12 is coupled with those commercial Li-containing cathode materials (i.e., LiFePO₄, LiCoO₂, LiNi_{0.8}Co_{0.1}Mn_{0.1}O₂, etc.) for a whole battery.

Inspired by semi-solid flow batteries, a specially designed flow cell 16 was designed to prepare the pre-SEI graphite powder 12 of the present disclosure. For practical operation, the pre-SEI graphite 12 was prepared by mixing graphite powder with electrolyte 22 of lithium-ion batteries and followed by an electrochemical discharge/charge process (0.005-2.0 V vs. Li⁺/Li) in the flow cell 16 to mimic the formation of SEI in normal coin-type battery cells, as shown in FIGS. 1A and 1B, while a Li foil 38 was used as a reference and counter electrode. The Li accommodation in the graphite powder anode can be simply controlled by the operating conditions of the flow cell apparatus 10, such as the cycling time and current density in the flow cell 16, for the electrochemical SEI formation. Once the graphite particles 14, dispersed in the electrolyte 22, flow directly and contact with the electrode of cathode chamber (cathode 26), the graphite particles 14 gain electrons and form the SEI layer 40 with subsequent reduction of electrolyte at a desired potential range (e.g., <1.0 V vs. Li⁺/Li) as demonstrated in FIG. 1B, illustrating cell discharge. As a result, an SEI layer 40 is formed on the exterior surface of the individual graphite particles 14.

It has been widely accepted that small current is favorable for the SEI formation process. Different current densities were applied to explore the SEI formation process in the flow cell 16. At a quite large current density ( 1/100 C), there was limited SEI 40 formed (<2 mAh g⁻¹). Such low Li compensation makes it hard to be transformed to practical lithium-ion batteries. However, a further reduction of formation current to 1/600 C led to a considerable SEI formation (˜27.6 mAh g⁻¹). The contact between current collector (e.g., cathode 26) and dispersed graphite particles 14 in the suspension 24 appears to be important to ensure the preformed SEI propagation. A greatly reduced SEI preformation was found when the flow rate was elevated from 10 mL/mins to 20 mL/mins (˜5.5 mAh g⁻¹). Moreover, there is very limited lithium intercalation because the formation of the insulating SEI layer 40 stops the further reaction between Li ions and the graphite particles 14 covered with the SEI layer 40. Such conclusion was further verified using X-ray powder diffraction (XRD), which presents a typical graphite layered structure patterns. After the formation of SEI on graphite, there is a 0.07° shift of the 2θ value (002 peak) to a higher degree. Typically, the graphite (022) peak shifts to a lower degree value along with the intercalation of lithium ions. The slight difference may come from the XRD measurement process (e.g., sample height difference). Accordingly, an SEI capacity as high as 27.6 mAh g⁻¹ (7.4% of theoretical capacity of graphite) was formed in the pre-SEI graphite 12 of the present invention at a low current density condition.

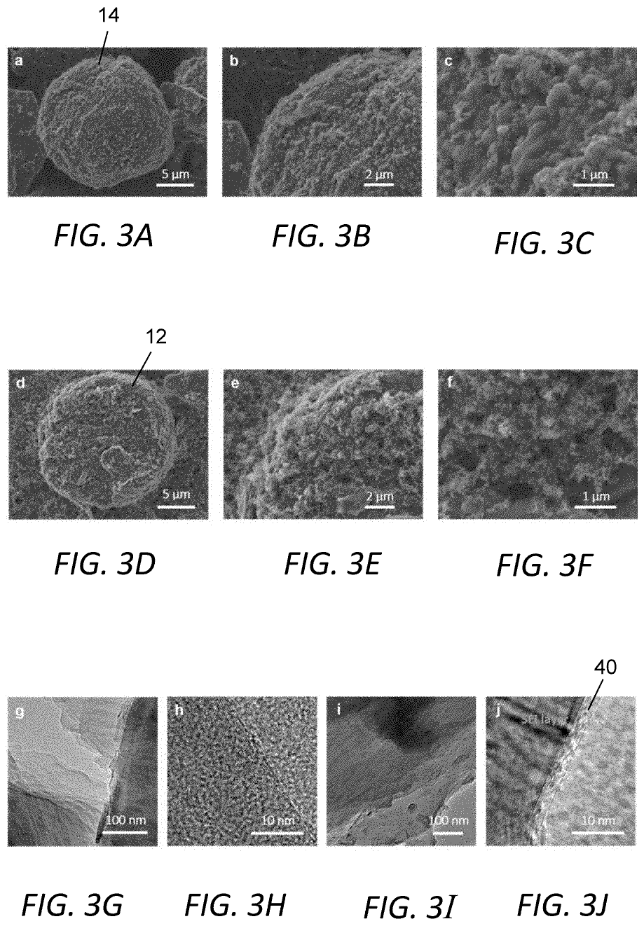

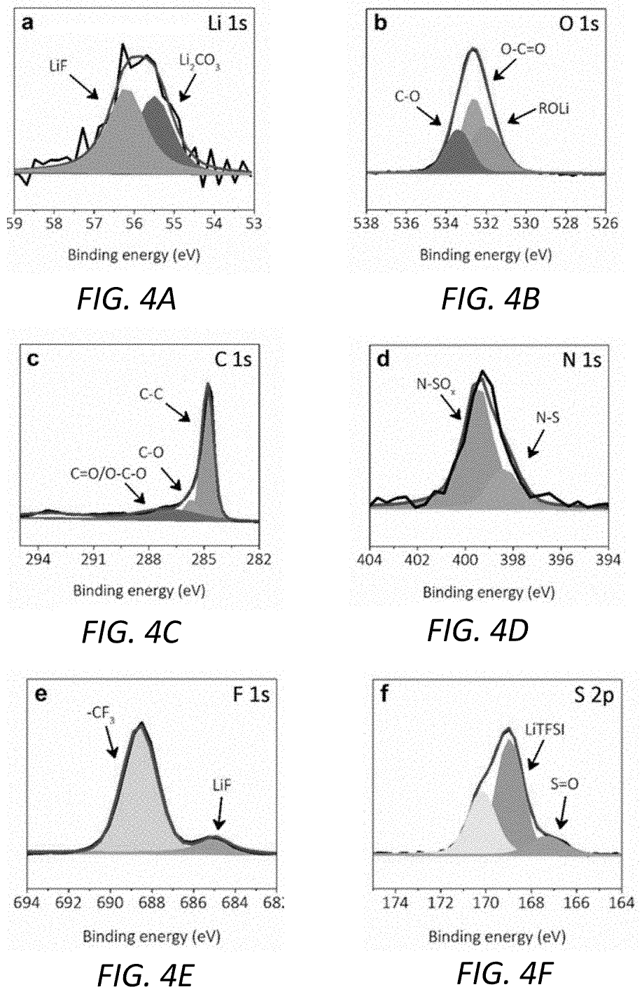

SEI structures of Pre-SEI graphite: Turning now to FIGS. 3A-3J, the SEI structure of the present invention was investigated using electron microscope (SEM & TEM) and X-ray photoelectron spectroscopy (XPS). As seen in in FIGS. 3D-3F, SEM images of the SEI layer 40 formed on the surface of Pre-SEI graphite 12 shows a porous and rough morphology compared with the surfaces of pristine graphite particles as seen in FIGS. 3A-3C. Such rough morphology has been further confirmed by TEM imaging. As seen in FIGS. 3G and 3H, pristine graphite shows a clear surface with a layer structure. In contrast, as seen in FIG. 31, a rough surface of Pre-SEI graphite 12 is formed by the decoration of SEI components. In particular, as seen in FIG. 3J, an SEI layer 40 with a thickness of 3-4 nm can be observed by the high-resolution TEM. XPS analysis was further performed to study the chemical compositions of the SEI layer 40 formed in the flow cell 16. Elements of C, O, S, Li, N, and F were present in the pre-SEI graphite 12 of the present invention, whereas elements of S, Li, N, and F were not detected in the pristine graphite sample. Selected elements of Li 1s, C 1s, O 1s, N 1s, F 1s and S 2p spectra of the pre-SEI graphite 12 can be seen in FIGS. 4A through 4F. The C 1s spectra and O 1s spectra of the pre-SEI graphite 12 are similar to a graphite sample, which both demonstrates a C—C and C—O bond located at ˜285 and 286.5 eV, respectively. In contrast, new peaks located at ˜287.5 and ˜531.5 eV are found in the pre-SEI graphite 12, which it is believed can be ascribed to C═O/O—C—O and ROLi in the C 1s and O 1s spectra, respectively. Most importantly, Li₂CO₃ and LiF have been revealed from Li 1s (FIG. 4E, —55.5 eV for Li₂CO₃ and ˜56.2 eV for LiF) and F 1s spectra (FIG. 4E, —685 eV for LiF), which are typical inorganic components of SEI structure. It is believed that the S 2p₃/2 peak at ˜169 eV could be attributed to the LiTFSI salts, which is in agreement with the N—S peak in the N 1s spectra in FIG. 4D. The lower energy binding peak (˜167 eV) can be traced to the S═O bonding from the decomposition products of the LiTFSI salts. These results strongly indicate that a SEI layer 40 has been formed over the surface of the graphite particles 14 after the treatment in the flow cell system 10 as described herein.

It has been widely accepted that the SEI structures dictate the electrochemical performance of battery materials. However, up till now, the SEI formation process was typically limited within the battery cell, which means that the electrolyte additives for a stable SEI formation have to be compatible with anode and cathode materials. In this regard, the flow cell system 10 of the present invention may also provide a way to artificially pre-design SEI structures outside the battery cell by simply modifying electrolyte components without the limitation of battery materials compatibility.

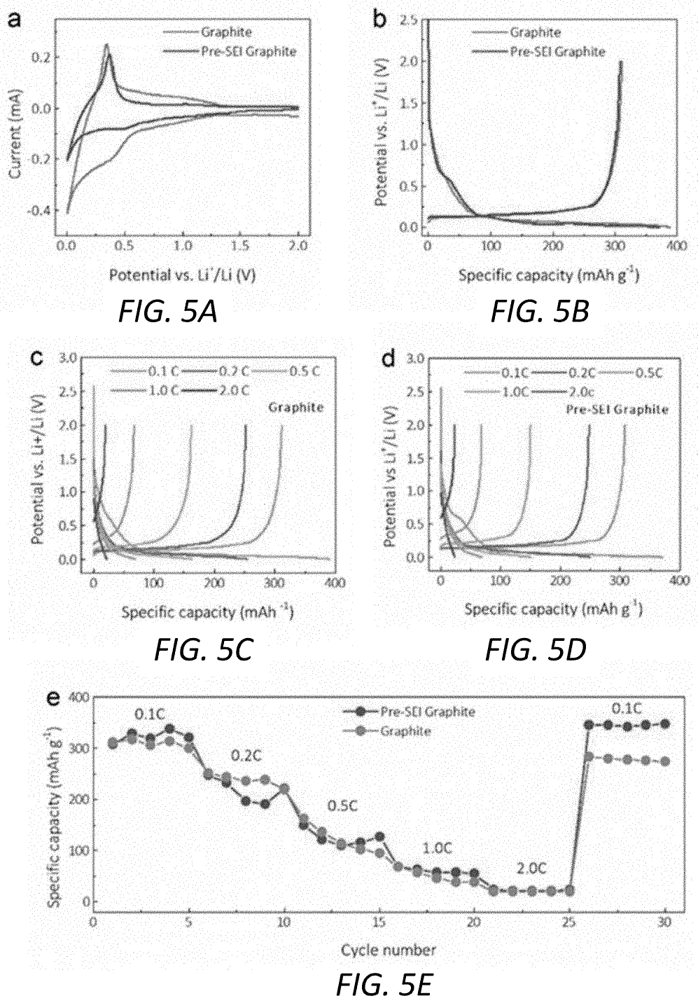

Electrochemical performance of Pre-SEI graphite: The possibility of using the SEI preformed graphite 12 to offset initial lithium loss in an electrochemical battery cell was also experimentally investigated. FIG. 5A reveals the comparison of initial cyclic voltammetry (CV) curves between graphite and Pre-SEI graphite. The cathodic peak of pre-SEI graphite 12 located around 0.5 V (vs. Li⁺/Li) is greatly reduced compared with a pristine graphite anode, which has been considered as the formation of SEI with the decomposition of electrolyte. The reduced double layer charging in the CV curve from pre-SEI graphite 12 suggests the formation of the SEI layer 40 over the graphite surface because the preformed SEI layer 40 reduces the surface area of graphite powder. Such reduction indicates that the preformed SEI layer 40 is able to mitigate the further propagation of SEI structure. This finding is well aligned with the initial charge/discharge curves of graphite and pre-SEI graphite half-cells, in which ˜25 mAh g⁻¹ of the initial capacity loss has been compensated, thanks to the preformation of SEI layer (FIG. 5B). The ICE of a pristine graphite has been improved from ˜76.7% to ˜80.4% of the pre-SEI graphite. The structure integrity of pre-SEI graphite 12 was further examined in half-cells with long term cycling and C-rate testing. The pre-SEI graphite 12 illustrates a stable cycling performance (0.1 C for 100 cycles) and C-rate capability (FIGS. 5C-5E), which is comparable with pristine graphite, suggesting a structure integrity after flow cell treatment. This finding is consistent with the XRD results. Surprisingly, the pre-SEI graphite 12 even demonstrates a higher capacity recovery after higher C-rate testing (2 C). It is possible that such a better capacity recovery comes from the reduced surface damage induced by solvent co-intercalation. In traditional EC-based electrolyte, a SEI is formed of organic species and LiF, which tends to be formed. However, two inorganic components include LiF and Li₂CO₃ have been observed as the main components from the XPS results (FIG. 4A). The SEI component of Li₂CO₃ is capable of reducing graphite surface damage by preventing solvent co-intercalation. As a result, a better capacity recovery is presented in the pre-SEI graphite 12 of the present disclosure because of a smaller surface damage at high rate charge and discharge. Such interesting findings illustrate a great potential of pre-SEI formation techniques in accordance with the present invention for an improved electrochemical performance with rational design of SEI structure.

An EIS experiment was carried out to study the interfacial properties of the SEI preformed (pre-SEI) graphite 12. The wetting degree of the electrolyte 22 with the electrode could be measured by the high frequency resistance (HFR) of the cell. It was found that the electrode formed with pre-SEI graphite 12 of the present invention demonstrates a slightly smaller HFR (˜2.9 Ω) compared with pristine graphite (˜3.0 Ω), suggesting a higher wetting degree due to the preformation of the SEI layer 40.

The electrochemical performance of the pre-SEI graphite 12 was evaluated in full electrochemical cells by incorporating the pre-SEI graphite 12 with LiFePO₄ (LFP) cathode materials. The mass ratio between LFP and pre-SEI graphite 12 (or graphite) was carefully controlled to 2.8:1, which was corresponding to a N/P ratio of ˜1.02. The full cell composed of LFP and Pre-SEI graphite cell exhibited an ICE value of 50.5%, which is 10.1% higher than those in pristine graphite anode cells (40.4%). Accordingly, the reversible cathode specific capacity with pre-SEI graphite of the present invention is 23.7% higher compared with the conventional graphite anode cells (18.6 mAh g⁻¹) after 100 cycles at 0.1 C rate. The increased capacity retention is benefited from the reduced initial lithium loss with preformed SEI graphite 12 on the graphite anode.

Conclusions: A new pre-SEI graphite concept is disclosed that is believed to compensate the ICL of lithium-ion batteries, which is intrinsically different from previously known cathode or anode prelithiation strategies. Owing to the preformation of SEI 40 on graphite particles 14, the improvement of the CE has been confirmed in both half-cells and LFP based full cells. A higher ICE of the pre-SEI graphite 12 could be further obtained by tuning SEI formation electrolyte components in flow cells. Thus, more explorations based on the pre-SEI concepts disclosed herein, such as specific flow cell designs and current control, may provide a complete solution to fully address the ICL issue of the conventional technology. The direct Li compensation of freestanding graphite powders makes it easy to meet the requirements for industrial scale-up. Moreover, the SEI preformed graphite concepts disclosed herein may further allow the pre-design of specific SEI structure outside the battery cells with the modification of the electrolyte components, and may be a transformative strategy to next-generation high-capacity anode materials with low ICE such as Si and Sn, which opens a new avenue to fully unlock the energy density potential of practical Li-ion batteries.

As previously noted above, though the foregoing detailed description describes certain aspects of one or more particular embodiments of the invention, alternatives could be adopted by one skilled in the art. For example, the methods, apparatus, products, and their components, could differ in appearance and construction from the embodiments described herein and shown in the drawings, functions of certain components of the methods, apparatus, products, and their components, could be performed by components of different construction but capable of a similar (though not necessarily equivalent) function, and various materials could be used in the fabrication of the apparatus, products, and/or their components. As such, and again as was previously noted, it should be understood that the invention is not necessarily limited to any particular embodiment described herein or illustrated in the drawings.

1. A method of making SEI preformed graphite, the method comprising:
disposing a suspension of graphite particles in an electrolyte between and in ionic contact with a cathode and an anode, wherein the anode comprises a lithium source; and
forming an SEI coating on the individual graphite particles in the suspension by generating a voltage between the cathode and the anode and across the suspension.

2. The method of claim 1, further comprising:
contacting the individual graphite particles in the suspension against the cathode while the voltage is being generated.

3. The method of claim 2, further comprising:
generating a flow of the suspension against the cathode to contact the individual graphite particles against the cathode.

4. The method of claim 3, further comprising:
generating the flow by pumping the suspension through a reaction space defined between a porous interlayer and the cathode.

5. The method of claim 4, wherein voltage is between 0.005 V and 2 V.

6. The method of claim 4, wherein the voltage generates a current density of less than 1/100 C.

7. The method of claim 6, wherein the voltage generates a current density of 1/600 C.

8. The method of claim 6, wherein the flow through the reaction space is less than 20 mL/min.

9. The method of claim 8, wherein the flow through reaction space is between 10 mL/min and 20 mL/min.

10. The method of claim 1, further comprising:
forming the suspension of graphite particles in the electrolyte by mixing graphite powder with an electrolyte.

11. The method of claim 1, wherein the lithium source comprises a lithium foil.

12. An SEI preformed graphite comprising:
a graphite powder comprising separate individual graphite particles; and
a preformed SEI layer on each of a plurality of the graphite particles in powder form,
wherein the SEI layer is directly formed over and substantially completely covers the exterior surface of each of the plurality of graphite particle in the graphite powder.

13. The SEI preformed graphite of claim 12, wherein the SEI layer comprises Li₂CO₃.

14. The SEI preformed graphite of claim 12, wherein the SEI layer comprises LiF.

15. The SEI preformed graphite of claim 12, wherein the SEI layer covering has a porous and rough morphology.

16. The SEI preformed graphite of claim 12, wherein the SEI layer has a thickness of 3-4 nm.

17. An electrochemical battery cell comprising:
a first electrode comprising the SEI preformed graphite of claim 12;
a second electrode; and
an electrolyte operatively coupling the first electrode with the second electrode to allow ions to flow from the one of the electrodes to the other of the electrodes.

18. The electrochemical battery cell of claim 17, wherein the first electrode comprises an anode formed of the SEI preformed graphite, conductive carbon black, and a binder that binds together the SEI preformed graphite and the conductive carbon black in the form of the anode, and
wherein the second electrode comprises a lithium transition metal oxide cathode, and
wherein the electrolyte comprises a lithium salt dissolved in a solvent.

19. A flow cell apparatus for forming SEI preformed graphite, the flow cell apparatus comprising:
a cathode;
an anode spaced apart from the cathode and forming a volume between the cathode and the anode, wherein the anode comprises lithium;
a battery separator disposed between and separating the volume between the cathode and the anode;
a permeable interlayer disposed between the battery separator and the cathode and defining a flow space between the interlayer and the battery separator and within the volume;
a mixer configured to mix graphite powder in an electrolyte; and
a pump configured to provide a flow of mixed graphite powder and electrolyte from the mixer to the flow space to engage graphite particles of the graphite powder against the cathode.

20. The flow cell apparatus of claim 19, further comprising:
a mixture of graphite powder in electrolyte mixed by the mixer,
wherein application of a voltage across the cathode and the anode while a flow of the mixture from the mixer flows through the flow space forms an SEI coating on individual graphite particles of the graphite powder in the flow space.
